(19) United States
(12) Patent Application Publication
(10) Pub. No.: US 2002/0156788 A1
(43) Pub. Date: Oct. 24, 2002

(54) Method of constructing, editing, indexing, and matching up with information on the interner for a knowledge map

(76) Inventor: Jia-Sheng Heh, Yung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/122,312

(22) Filed: Apr. 16, 2002

(30) Foreign Application Priority Data
Apr. 20, 2001 (TW) 90109519

(51) Int. Cl. G06F 7/00

(52) U.S. Cl. 707/10

(57) ABSTRACT

A method of constructing, editing, indexing, and matching up with information on the Internet for a knowledge map. This method of creating a knowledge map follows several processes. First, a new dataset is added to the knowledge map by inputting names and descriptions of new knowledge nodes', names of corresponding parent nodes, and type IDs according to different knowledge domains. The database system will then record the according knowledge node IDs, the parent node IDs, the names and descriptions of the new knowledge nodes, and the Knowledge Domains ID. As for the names and descriptions of the existed nodes on the knowledge map can be modified or deleted according to their knowledge node IDs. By using this knowledge map to search, classify, edit, and index information on the Internet, the gathered knowledge can be systematized into a digital library.

### FIELD OF THE INVENTION

### DESCRIPTION OF THE PRIOR ART

The present invention relates a way to represent a knowledge map and a method to deal with knowledge construction, especially to provide a method of constructing, editing, indexing, and matching up with information on the Internet for a knowledge map. The present invention allows users to construct, edit, and index a “knowledge map”. Users can then utilize the “knowledge map” to make gathered knowledge a digital library by classifying, constructing, editing, and indexing the knowledge according to individual needs.

### BACKGROUND OF THE INVENTION

With the rapid development of computer and Internet technology, the sources of information become abundant quickly. However, scattered information without system increases the inconvenience of indexing and browsing the information. In addition, the scattered information cannot be as useful and valuable as it is integrated, classified, and filed.

So far, there is no way for group institutions and individuals to classify, arrange, and file data such as web pages, files, or articles from different sources and systematize them into a digital library that meets the users' needs.

### SUMMARY OF THE INVENTION

It is therefore a primary object of the present invention to provide a method of constructing, editing, indexing, and matching up with information on the Internet for a knowledge map. Because a “knowledge map” can be built, edited, and indexed by utilizing this innovation, users are allowed to create a domain specific knowledge map according to different knowledge domains by classifying, constructing, editing, deleting, and adding the relevant information. In addition, users can use the knowledge map they build to index web information and make gathered information a digital library.

It is a further object of the present invention to provide a method which also allows users to compile information or articles from different web sources into personal data files and put onto the “knowledge map” so that individual's needs can be satisfied.

According to the above objects, the method of constructing, editing, indexing, and matching up with information on the Internet for a knowledge map is invented and introduced. The steps of constructing a knowledge map are described as following:

1. Check and decide in what knowledge domains a new knowledge node will be added.

2. Input the names and descriptions of knowledge nodes, the corresponding parent nodes, and their type IDs that are planned to add.

3. Add a record of data into the knowledge map according to the structure that is constructed previously. The knowledge node IDs, the corresponding parent node IDs, the names and description of added knowledge nodes, and the knowledge domain IDs will be recorded into database at the same time.

The steps of modifying a knowledge map of the present invention are described as following.

1. Key in the names of knowledge nodes that are planned to modify.

2. Modify the names and descriptions of those knowledge nodes as wanted.

The steps of deleting data on a knowledge map of the present invention are described as following.

1. Choose the knowledge nodes that are planned to delete.

2. Delete the data of a certain knowledge node from the knowledge map according to its type ID.

The steps of searching information using a knowledge map of the present invention are described as following.

1. Input the names of chosen knowledge nodes and their codes.

2. Search and list related web pages, files, articles according to the chosen knowledge nodes.

The steps of indexing information into a knowledge map of the present invention are described as following.

1. Insert the web pages, files, and articles that belong to the same knowledge node under that node.

The steps of classifying information into a knowledge map of the present invention are described as following.

1. Choose the needed information.

2. Choose or create a knowledge node on the knowledge map.

3. Add the web pages, files, and articles of the chosen information under the knowledge node.

The steps of matching up with information on the Internet for a knowledge map of the present invention are described as following.

1. Add the existing sub-content to each node of the knowledge map.

2. Pick several web pages, files, and articles related to the node, edit them, and save as a new file.

The present invention can be understood through the following descriptions and accompanying drawings wherein:

### BRIEF DESCRIPTION OF THE DRAWINGS

FIG. 1 is a flow chart diagram showing the method of constructing a knowledge map of the present invention;

FIG. 2 is a flow chart diagram showing the method of modifying a knowledge map of the present invention;

FIG. 3 is a flow chart diagram showing the method of deleting data on a knowledge map in the present invention;

FIG. 4 is a flow chart diagram showing the method of indexing a knowledge map of the present invention;

FIG. 5 is a flow chart diagram showing the method of classifying information into a knowledge map of the present invention; and

FIG. 6 is a flow chart diagram showing the method of matching up with information on the Internet for a knowledge map of the present invention.

### DETAILED DESCRIPTION OF THE PREFERRED EMBODIMENT

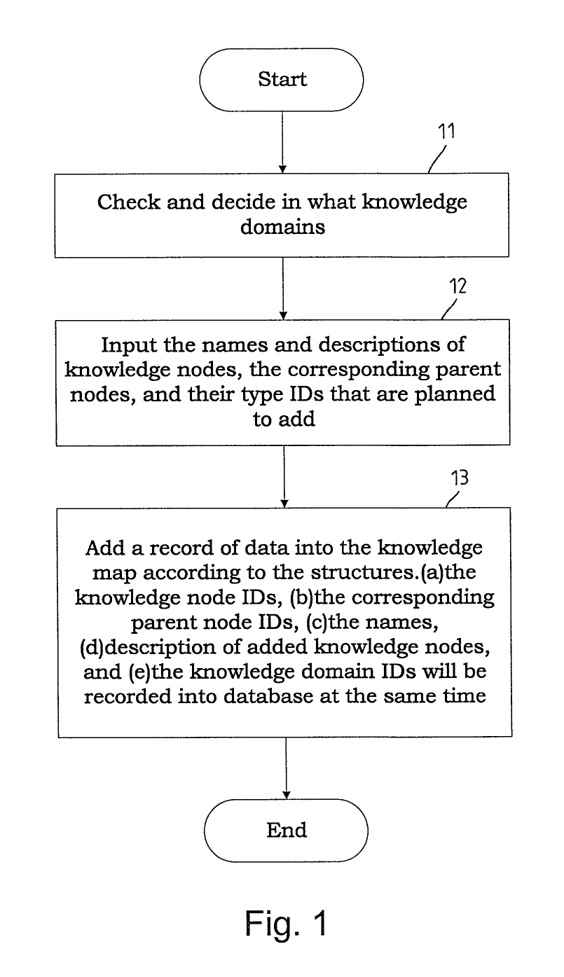

Please refer to FIG. 1. The present invention is to provide a method of constructing, editing, indexing, and matching up with information on the Internet for a knowledge map. The steps of constructing a knowledge map are described as following.

(a) Check and decide in what knowledge domains a new knowledge node will be added (11).

(b) Input the names and descriptions of knowledge nodes, the corresponding parent nodes, and their type IDs that are planned to add (12).

(c) Add a record of data into the knowledge map according to the structures that is constructed previously. The knowledge node IDs, the corresponding parent node IDs, the names and description of added knowledge nodes, and the knowledge domain IDs will be recorded into database at the same time (13).

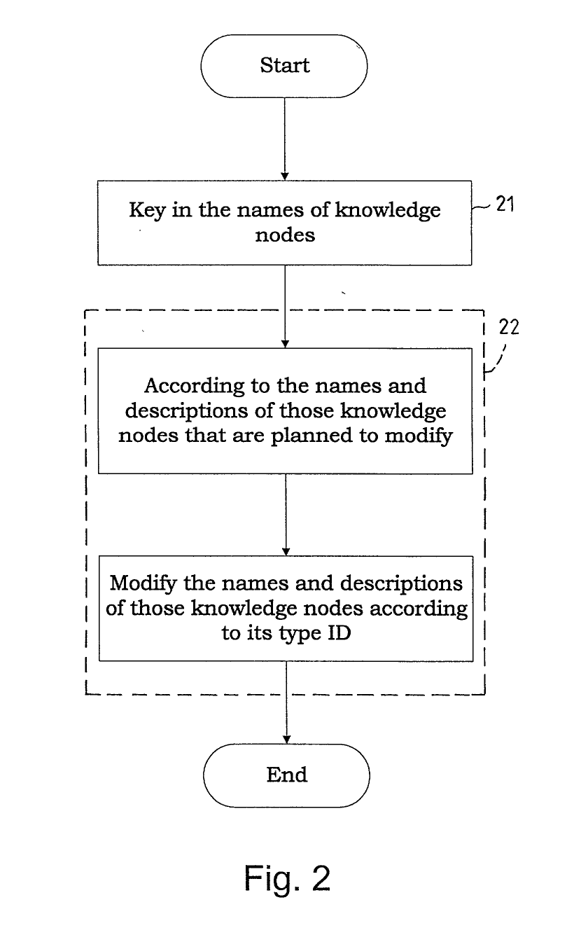

Please refer to FIG. 2. The steps of modifying a knowledge map are described as following.

(a) Key in the names of knowledge nodes that is planned to modify (21).

(b) Modify the names and descriptions of those knowledge nodes as wanted (22).

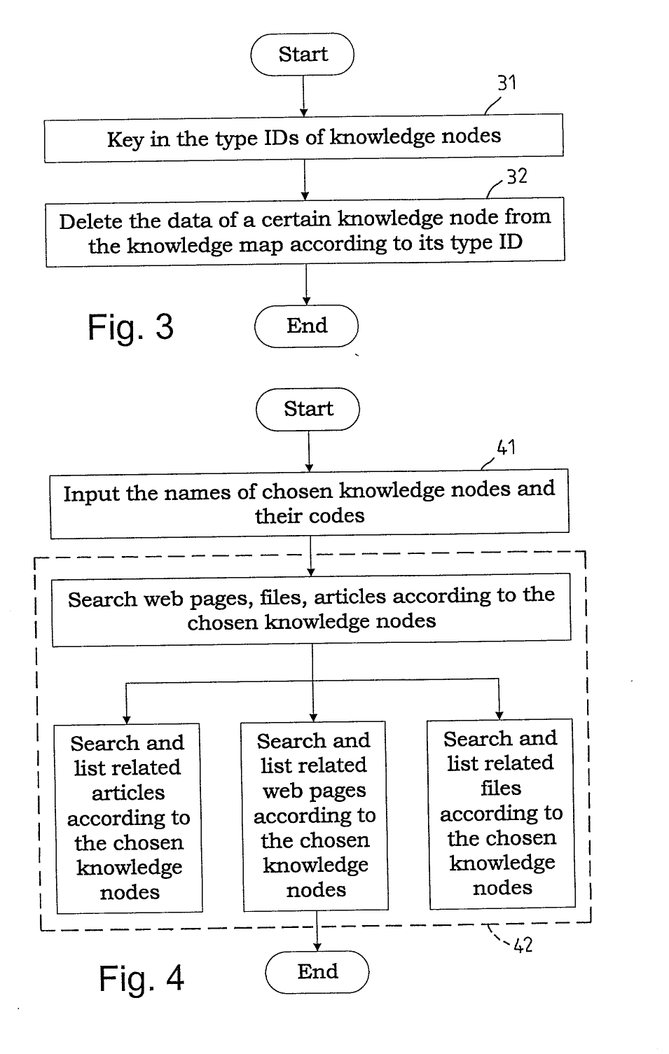

Please refer to FIG. 3. The steps of deleting data on a knowledge map are described as following.

(a) Choose the knowledge nodes that are planned to delete (31).

(b) Delete the data of a certain knowledge node from the knowledge map according to its type ID (32).

Please refer to FIG. 4. The steps of searching information using a knowledge map are described as following.

(a) Input the names of chosen knowledge nodes and their codes (41).

(b) Search and list related web pages, files, articles according to the chosen knowledge nodes (42).

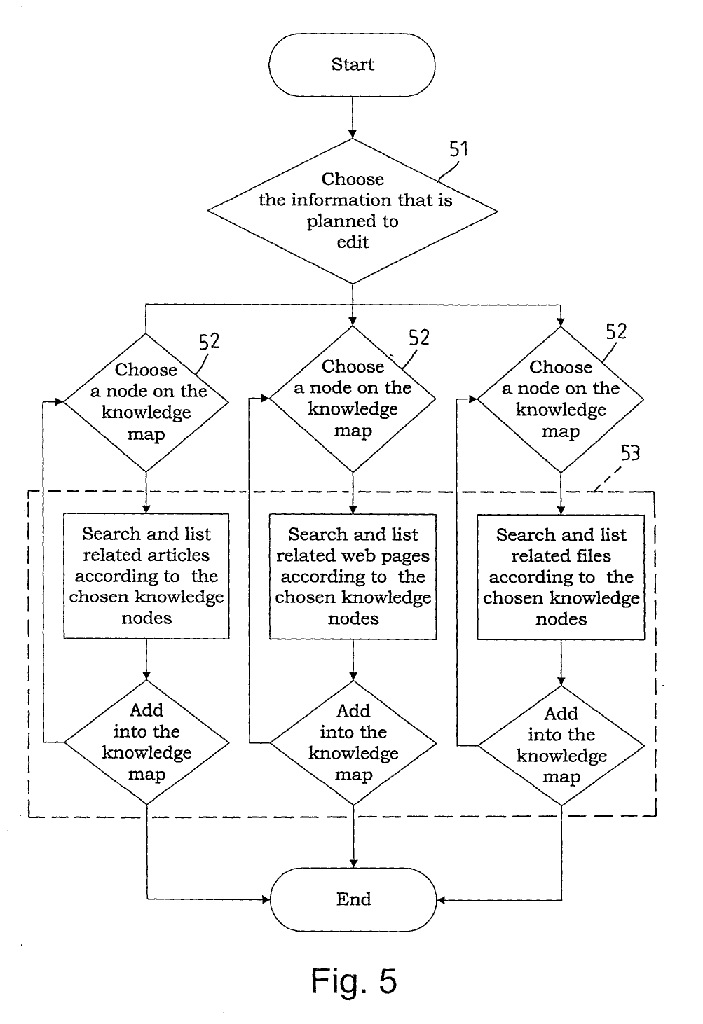

Please refer to FIG. 5. The steps of classifying information into a knowledge map are described as following.

(a) Choose the needed information (51).

(b) Choose or create a knowledge node on the knowledge map (52).

(c) Choose and add related web information into the chosen knowledge node (53).

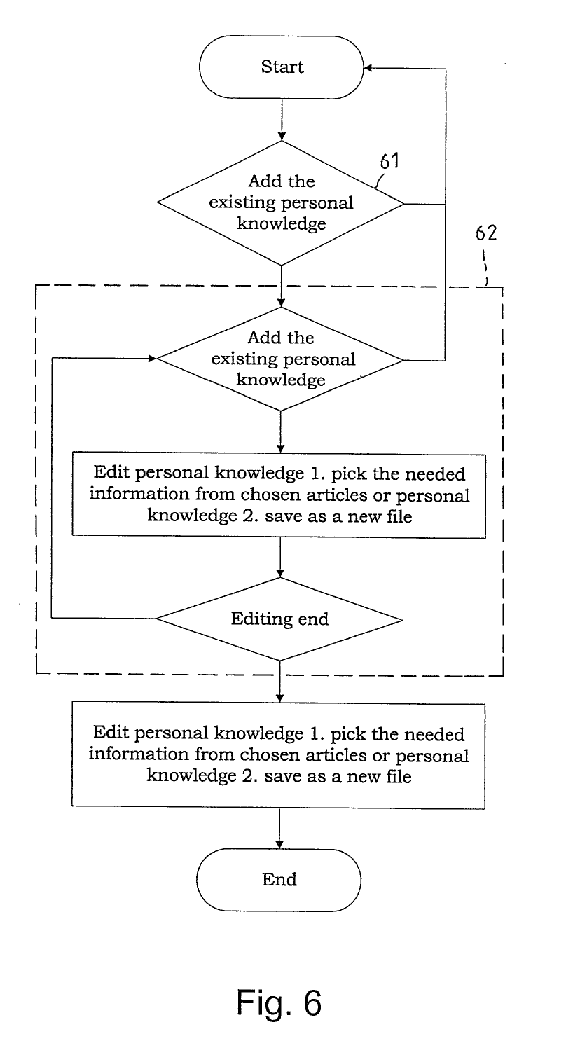

Please refer to FIG. 6. The steps of matching up with information on the Internet for a knowledge map are described as following.

(a) Add the existing sub-content to each node of the knowledge map (61).

(b) Pick several web pages, files, and articles related to the node, edit them, and save as a new file (62).

The methods introduced by the present invention can be utilized to construct any knowledge map such as “physics knowledge map” so that schools, organizations, institutions, or individuals can put up any knowledge map according to their own knowledge domains. The same methods can also be employed to build “personalized knowledge map” to satisfy one's specific needs.

As described earlier, the method of constructing, editing, indexing, and matching up with information on the Internet for a knowledge map introduced by the present invention can be used to build, edit, and index “knowledge map”. This allows users to construct a “knowledge map” according to a particular knowledge domain and to utilize the “knowledge map” to index information on the Internet so that gathered knowledge through this process can be systematized into a digital library.

The method of constructing, editing, indexing, and matching up with information on the Internet for a knowledge map introduced by the present invention can also allow users to organize information or articles that are from different web sources into a personal file and put onto “knowledge map” so that individual's needs of different users can be totally satisfied.

What is claims is:

1. A method of constructing, editing, indexing, and matching up with information on the Internet for a knowledge map. The steps of constructing a knowledge map including:
(a) checking and decide in what knowledge domains a new knowledge node will be added;
(b) inputting the names and descriptions of knowledge nodes, the corresponding parent nodes, and their type IDs that are planned to add; and
(c) adding a record of data into the knowledge map according to the structures that is constructed previously, the knowledge node IDs, the corresponding parent node IDs, the names and description of added knowledge nodes, and the knowledge domain IDs will be recorded into database at the same time.

2. The method as recited in claim 1, wherein the steps of modifying a knowledge map including:
(a) keying in the names of knowledge nodes that is planned to modify; and
(b) modifying the names and descriptions of those knowledge nodes as wanted.

3. The method as recited in claim 1, wherein the steps of deleting data on a knowledge map including:
(a) choosing the knowledge nodes that are planned to delete; and
(b) deleting the data of a certain knowledge node from the knowledge map according to its type ID.

4. The method as recited in claim 1, wherein the steps of searching information using a knowledge map including:
(a) inputting the names of chosen knowledge nodes and their codes; and
(b) searching and list related web pages, files, articles according to the chosen knowledge nodes.

5. The method as recited in claim 1, wherein the steps of indexing information into a knowledge map including:
inserting the web pages, files, and articles that belong to the same knowledge node under that node.

6. The method as recited in claim 1, wherein the steps of classifying information into a knowledge map including:
(a) choosing or create a knowledge node on the knowledge map; and
(b) choosing and add related web information into the chosen knowledge node.

7. The method as recited in claim 6, wherein the steps of editing and including sub-content into a knowledge map including:
(a) adding the existing sub-content to each node of the knowledge map; and
(b) picking several web pages, files, and articles related to the node, edit them, and save as a new file.
